(19) United States
(12) Patent Application Publication
(10) Pub. No.: US 2021/0059228 A1
(43) Pub. Date: Mar. 4, 2021

(54) AQUARIUM WALL CLEANER

(71) Applicant: Bruce TAYLOR, Kenner, LA (US)

(72) Inventor: Bruce TAYLOR, Kenner, LA (US)

(21) Appl. No.: 16/936,582

(22) Filed: Jul. 23, 2020

Related U.S. Application Data
(60) Provisional application No. 62/922,837, filed on Aug. 31, 2019.

(51) Int. Cl. A01K 63/10

(52) U.S. Cl. CPC A01K 63/10

(57) ABSTRACT

An aquarium wall cleaner for cleaning aquarium walls comprising a cleaning head attached to the lower end of a shaft gripped at its upper end by an aquarist, the shaft being able to freely reciprocate relative to an intermediate element that may apply a side-load to the shaft when gripped by the aquarist's other hand. A cleaning element attached to the cleaning head may also be a flexible blade whose extension may be adjusted, and the flexible blade may bend relative to one or both of its planar axes in order to conform to both flat and curved aquarium walls.

### RELATED APPLICATIONS

This application claims priority to U.S. Provisional Application No. 62/922,837 filed on Aug. 31, 2019 which is incorporated herein by reference.

### BACKGROUND OF THE INVENTION

### Field of the Invention

The present invention is a device for cleaning the inside of aquarium walls. Contaminants such as algae that accumulate on the inside of aquarium walls must be periodically removed by cleaning devices to maintain a clear view of the aquarium's contents. Existing wall cleaning devices used for this purpose have many disadvantages and limitations.

### Description of Prior Art

Referring to FIGS. 1a and 1b, a common conventional device 2 for cleaning aquarium walls uses magnetically-coupled halves with an inner half 4 positioned on the inner surface 6 of an aquarium wall 8 and an opposite outer half 10 positioned on the outer surface 12 of the same wall 8 when the device 2 is in use. A cleaning element 14, such as a metal or plastic blade 16 or an abrasive brush or pad 18 is mounted on the inner half 4 while the outer half 10 is held and guided by the aquarist (not shown). Three problems with these devices are that aquarists often get wet during use, they cannot be used on curved aquarium walls (not shown), and they are prone to scratching the inner surfaces 6 of aquarium walls 8.

For example, to initially magnetically-couple the halves 4, 10 the aquarist must put one hand into the aquarium 20 to position the inner half 4 adjacent the outer 10, then after cleaning one wall 8 again reach into the aquarium 20 to decouple and retrieve the inner half 4 and reposition it parallel to the next wall 8 to be cleaned, then when finished reach in once more to decouple the halves 4, 10 and retrieve the inner half 4. During these transitions the inner half 4 can also slip from the aquarist's grasp, falling to the bottom of the aquarium 20 from where it must be retrieved. If the aquarist prematurely pulls the outer half 10 away from the aquarium wall 8 or if the inner half 4 impacts objects inside the aquarium 20, such as aquarium framing 22 (shown in partial cut-away), substrate 24, or aquarium décor (not shown) such as coral or rocks, the magnetic coupling force 26 can be severed, again dropping the inner half 4 to the bottom of the aquarium 20.

To generate and maintain the magnetic coupling force 26 and produce a consistent cleaning force “Fc” the distance 28 between the two halves 4, 10 also must be minimized, effectively preventing magnetically-coupled cleaning devices 2 from being used on curved aquarium walls, such as those of cylindrical and bowed-front aquariums.

Referring still to FIGS. 1a and 1b, the pads 18 or the gap 30 defined by the exposed length 32 of blades 16 can also trap abrasives common in aquariums 20, such as particles of substrate 24 (gravel, shell fragments or crushed coral) or hard organic contaminants such as copepods (not shown) that attach to the inner surfaces 6 of aquarium walls 8. Subsequent reciprocating cleaning movement 34 can then cause the trapped abrasives to scratch the inner surfaces 6.

As the aquarist moves a magnetically-coupled device 2, its inner half 4 can also unintentionally rotate relative to its outer half 10, about the axis 36 perpendicular to the surface 6, and then if the cleaning element 14 is a sharp blade 16, the blade can scratch the inner surface 6 as it rotates.

Referring now to FIGS. 2 and 3, another common conventional device 38 typically uses a cleaning element 14 such as a brush or pad 40, or a rigid plastic or metal blade 42, mounted to a cleaning head 44 connected to the lower end 46 of a shaft 48. These shaft-mounted brushes or pads 40 can also trap abrasives that can scratch aquarium walls 8 and metal blades 42 can scratch walls 8 made of softer materials like acrylic, and even glass walls 8 if a metal blade 42 has edge imperfections or is moved parallel to its contacting edge 50.

Referring now to FIGS. 2, 3 and 4, existing shaft-style devices 38 have additional disadvantages and limitations, one being the inefficient and ineffective one-handed sideways stance aquarists 52 generally must assume during their use and another is that they are not suited to using flexible blades. The natural stance of an aquarist 52 during their use is to face roughly parallel to the wall 8 being cleaned, with one arm 54 nearest the aquarium 20, and with only that arm's hand 56 gripping only the upper end 58 of the shaft 48. Using only that arm 54 the aquarist 52 must then generate a contact cleaning force “Fc” by pulling with force “Fp” and/or applying a twisting moment “Mt”, while also pulling and pushing up and down with alternating force “Fr” to produce a reciprocating cleaning motion 34.

Referring now to FIGS. 4, 5 and 6, when the cleaning element 14 is a blade 42 the aquarist 52 also must control the angle 60 of the shaft 48 to the aquarium wall 8, in order to control the straight blade angle 62 (angle of a rigid blade 42 to the aquarium wall 8) for effective cleaning. However, applying this complex mix of forces “Fp” and “Fr”, moments “Mt” and movements 34 is difficult and physically straining, so it prevents the aquarist 52 from controlling the blade angle 62 tightly enough to use a flexible blade 64.

Referring now to only FIG. 5, if the angle 62 is too large a flexible blade 64 can chatter (alternately catching and releasing, producing abrupt changes in the bowed blade angle 66 along the line of contact 50) as it is reciprocated in the direction shown by line 34, which can scratch particularly softer wall materials like acrylic. Conversely, and referring now to only FIG. 6, if the angle 62 is too small the flexible blade 64 can bow too much, its bowed angle 66 then becoming nearly tangential to the inner surface 6 of the aquarium wall 8, preventing the flexible blade 64 from scraping and cleaning the surface 6.

### SUMMARY OF THE INVENTION

The present invention is an aquarium wall cleaner that includes a shaft intended to be gripped toward its upper end by one hand of an aquarist, a cleaning head attached to the lower end of the shaft and to which a cleaning element is attached, and an intermediate element (hereinafter referred to either descriptively as the “lower sliding grip-sleeve” or as just the “sleeve”) intended to be gripped by the second and lower hand of the aquarist, in order to constrain the lateral movement of the shaft while still allowing the shaft to freely reciprocate relative to the sleeve. The aquarist then typically applies a pulling force “Fp” on the lower sliding grip-sleeve and a concurrent opposing force “Fb” toward the upper end of the shaft in order to generate a counterbalancing contact cleaning force “Fc” between the cleaning element and the aquarium wall.

The two-handed grip and resulting three-point force balance defined by loads “Fp”, “Fb” and “Fc” then allows the aquarist to better control the shaft angle, in order to better control the straight blade angle and resulting bowed blade angle of a flexible blade. The aquarium wall cleaner can then optionally use flexible blades to enable cleaning of both flat aquarium walls and the curved walls (not shown) of cylindrical and bowed-front aquariums.

### BRIEF DESCRIPTION OF THE DRAWINGS

FIGS. 1a and 1b are side views showing a prior art magnetically-coupled cleaning device.

FIGS. 2 and 3 are side views showing prior art shaft-style cleaning devices.

FIG. 4 is a simplified elevational view showing how aquarists typically hold a prior art shaft-style cleaning device.

FIGS. 5 and 6 are close-ups of Detail “A” of the prior art cleaning device shown in FIG. 3, showing the lower end of a conventional shaft-style cleaning device.

FIGS. 7 and 8 are simplified elevational views of the aquarium wall cleaner of the present invention as typically held by an aquarist.

FIG. 9 is an elevational view showing the locations of applied and generated forces during typical use of the aquarium wall cleaners shown in FIGS. 7 and 8.

FIG. 10 is a close-up of Detail “A” of the aquarium wall cleaner shown in FIG. 7, showing the lower end of said aquarium wall cleaner.

FIGS. 11a and 11b are sectional side and top views, respectively, of an embodiment of the aquarium wall cleaners shown in FIGS. 7 and 8.

FIG. 12 is a partial cut-away side view of a portion of another embodiment of the aquarium wall cleaner of the present invention.

FIGS. 13a and 13b are top and sectional side views, respectively, of another embodiment of the aquarium wall cleaner of the present invention.

FIGS. 14a and 14b are top and sectional side views, respectively, of another embodiment of the aquarium wall cleaner of the present invention.

FIGS. 15a and 15b are side and top views, respectively, of the lower end of another embodiment of the present invention.

FIGS. 16a and 16b are sectional side views of the embodiment illustrated in FIGS. 15a and 15b.

FIGS. 17a and 17b are top and side views of a cleaning element that may be used with the embodiments illustrated in FIGS. 15a, 15b, 16a, 16b, 18a, 18b, 18c, 19 and 20.

FIGS. 18a, 18b and 18c are top, rear and sectional side views, respectively, of the lower end of another embodiment of the present invention.

FIG. 19 is a close-up of the sectional side view in FIG. 18c.

FIG. 20 is a top view showing an embodiment of the present invention being repositioned to sequentially clean multiple aquarium walls.

FIG. 21 is a simplified side view illustrating multiple additional features that may be incorporated into the present invention.

FIG. 22 is side view showing a pivoting feature that may be added to the present invention.

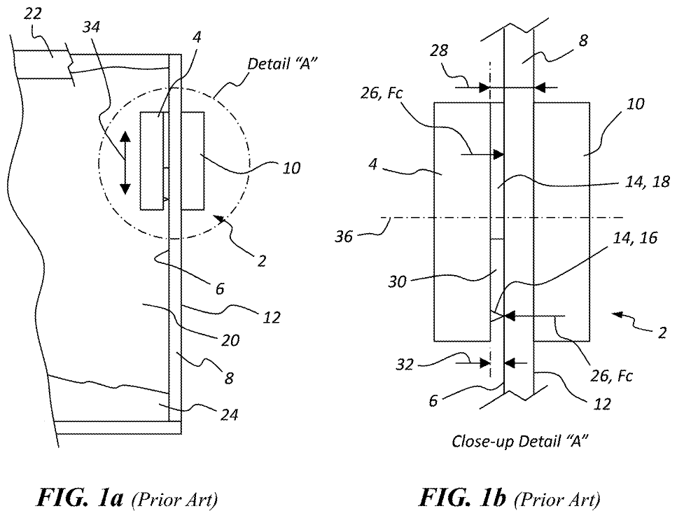

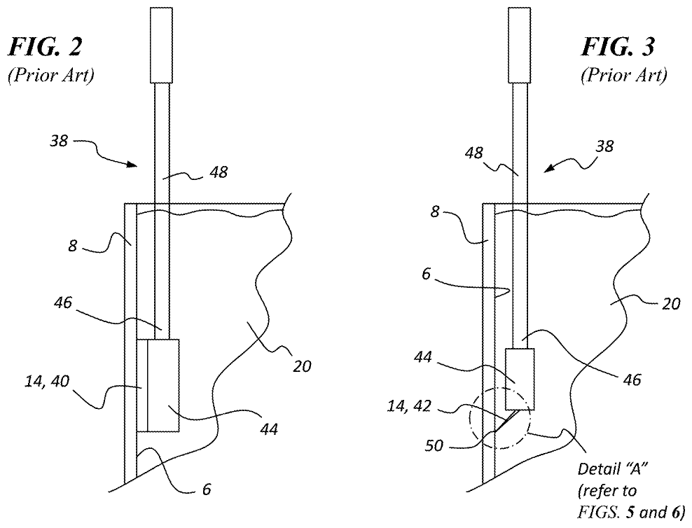

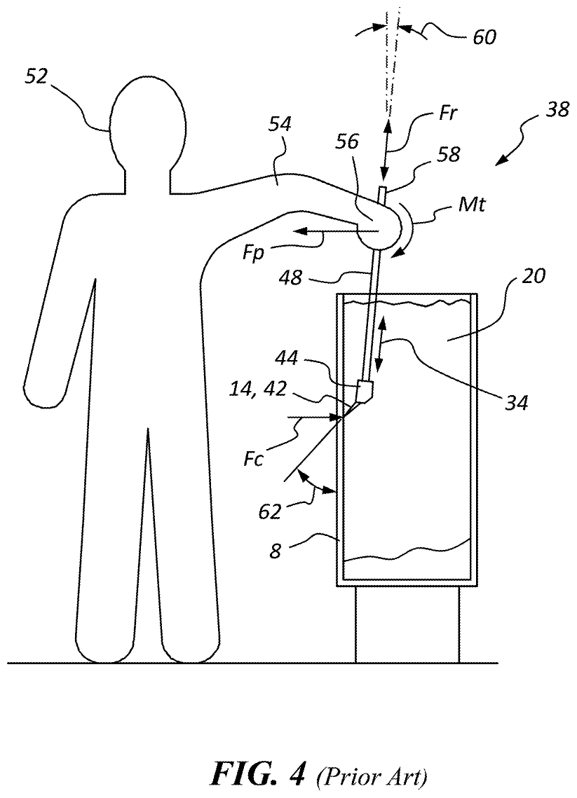

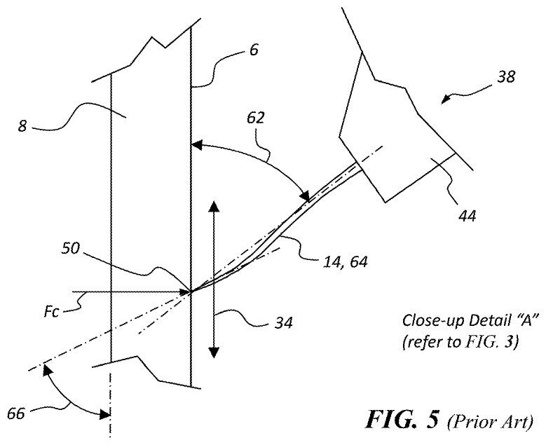

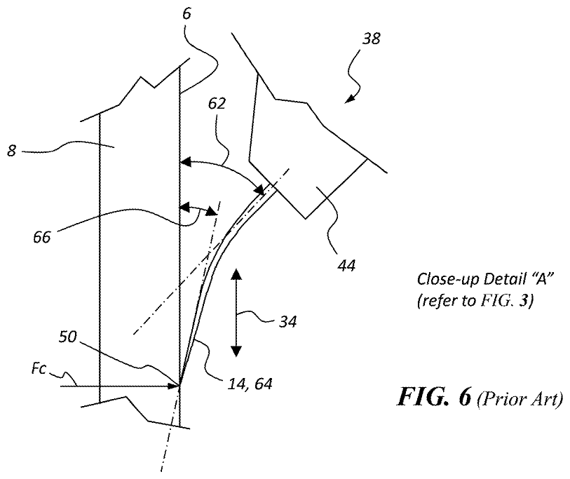

### DETAILED DESCRIPTION OF THE DRAWINGS

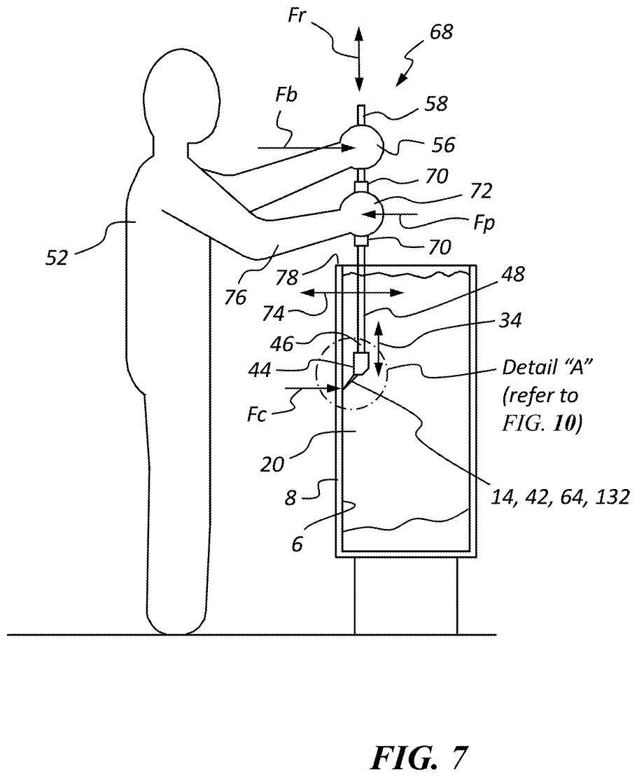

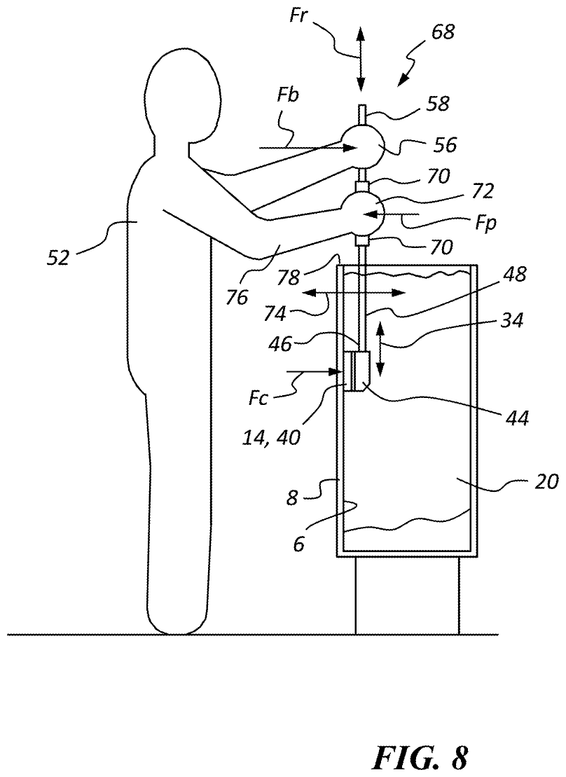

Referring now to FIGS. 7, 8 and 9, an aquarium wall cleaner 68 of the present invention includes a shaft 48 intended to be gripped toward its upper end 58 by one hand 56 of an aquarist 52, a cleaning head 44 attached to the lower end 46 of the shaft 48 and to which a cleaning element 14 is attached, and a sleeve 70 intended to be gripped by the second and lower hand 72 of the aquarist 52, in order to constrain the lateral movement 74 of the shaft 48 while still allowing the shaft 48 to freely reciprocate 34 relative to the sleeve 70. The aquarist 52 then typically applies a pulling force “Fp” on the lower sliding grip-sleeve 70 and a concurrent opposing force “Fb” toward the upper end 58 of the shaft 48 in order to generate a counterbalancing contact cleaning force “Fc” between the cleaning element 14 and the inner surface 6 of the aquarium wall 8. The aquarist 52 then also uses his/her upper hand 56 to apply a reciprocating axial force “Fr” to the shaft 48 in order to generate the required reciprocating cleaning motion 34.

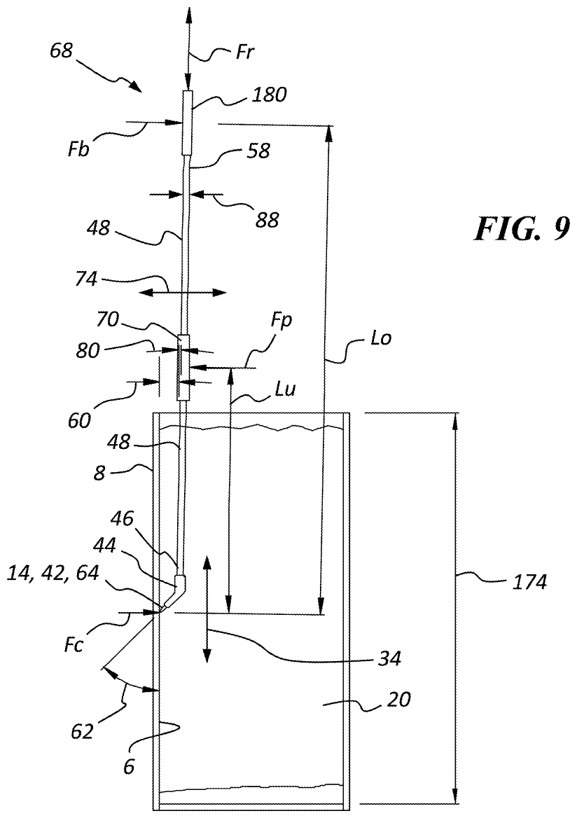

Referring now to FIGS. 7, 8, 9 and 10, the two-handed grip 56, 72 and resulting three-point force balance defined by loads “Fp”, “Fb” and “Fc” then allows the aquarist 52 to better control the shaft angle 60, in order to better control the straight blade angle 62 (FIG. 9) and resulting bowed blade angle 66 (FIG. 10), allowing the aquarium wall cleaner 68 to then optionally use flexible blades 64 in lieu of rigid plastic or metal blades 42, or brushes or pads 40, to enable cleaning of both flat aquarium walls 8 and the curved walls (not shown) of cylindrical and bowed-front aquariums.

The intended two-handed stance of the aquarist 52 when using the aquarium wall cleaner 68 is to substantially face the aquarium wall 8 being cleaned, thus allowing the aquarist 52 to comfortably view the cleaning process. When helpful, this stance also allows the aquarist 52 to rest his/her lower arm 76 on the top lip 78 of the aquarium 20, to more easily prevent the sleeve 70 and hence the shaft 48 from unintentionally moving laterally 74, in order to generate and maintain a higher contact cleaning force “Fc”. In addition, when the cleaning element 14 is a blade 42, 64 this also allows for better control of the unbowed angle 60 of the shaft 48 and hence the straight blade angle 62, and thence the bowed blade angle 66 if flexible blades 64 are used.

Referring now to only FIG. 9, using the sleeve 70 to reduce the unsupported length “Lu” of the shaft 48 to further reduce and control the shaft's angle of curvature 80 (the angle between the tangents to the shaft 48 at its lower 46 and upper 58 ends), in turn enables better control of the angle 62 when blades 42, 64 are used.

Referring now to FIGS. 7, 8, 11a and 11b, the shaft 48 can be permitted to reciprocate in the direction shown by line 34 freely through the lower sliding grip-sleeve 70 by multiple means, including by combining a sleeve 70 with a relatively soft and low-friction inner surface 82 with a shaft 48 that has a relatively hard and low-friction outer surface 84. The inner diameter 86 of the sleeve 70 can then be sufficiently larger than the outer diameter 88 of the shaft 48 to allow easy slippage between them along their vertical line of contact 90 when they are forced together by the application of opposing forces “Fp”, “Fb” and “Fc”. The outer diameter 92 of the sleeve 70 should also be large enough for the aquarist 52 to comfortably grip and the outer diameter 88 of the shaft 48 large enough to render the shaft 48 sufficiently strong and stiff.

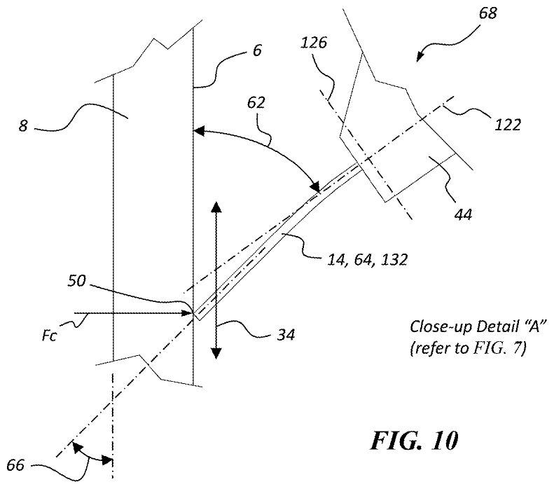

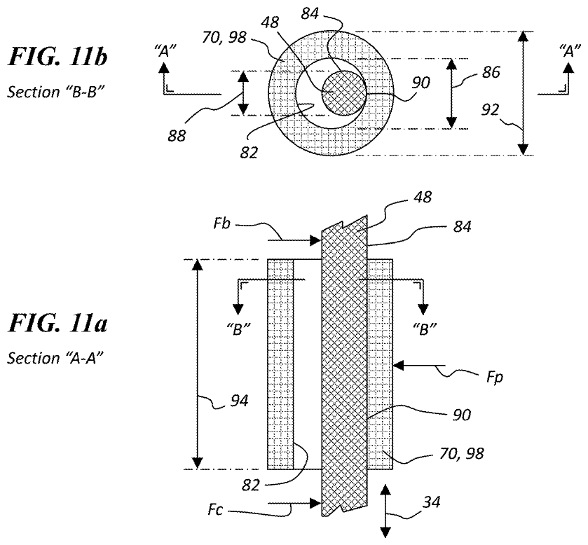

Referring now to FIGS. 9, 11a and 11b, the shaft 48 is also strong enough to permit application of an adequate cleaning force “Fc” without breaking. A stiffer shaft 48 also bends less to maintain longer tangential contact along line 90 with the inner surface 82 of the lower sliding grip-sleeve 70 and to better maintain the blade angle 62. Making the shaft 48 from a stronger, stiffer material also allows its outer diameter 88 to be reduced, to reduce weight and cost, and its sufficiently strong overall length “Lo” to be increased to clean deeper aquariums 20.

The shaft 48 may then be made, by way of example, from a light-weight, durable, hard and stiff material with a low-friction outer surface 84, such as protruded carbon-fiber rod, while the lower sliding grip-sleeve 70 may be made from a light-weight, durable, yet softer tubular material with a low-friction inner surface 82, such as high-density polyethylene (HDPE) plastic tubing.

Again by way of example and referring still to FIGS. 9, 11a and 11b, a protruded carbon-fiber shaft 48 with an outer diameter 88 of about 0.375 inches is sufficiently light-weight, stiff and strong for effective and reliable use with overall shaft lengths “Lo” of 48 inches or more. Furthermore, a tubular HDPE sleeve 70 with an approximate inner diameter 86 and outer diameter 92 of 0.50 inches and 0.625 inches respectively, and a length 94 of approximately 4 inches, is sufficiently large to comfortably grip, while the difference between the inner diameter 86 of the sleeve 70 and outer diameter 88 of the shaft 48 is also sufficiently large to permit easy slippage between them.

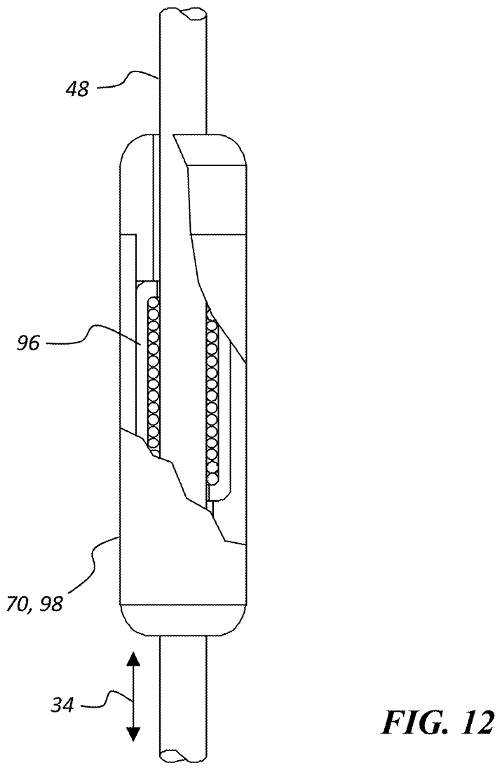

Referring now to FIGS. 7, 8, 9, 10, 11a and 11b, while the above-described use of a simple tubular sleeve 70 is effective, other means can achieve the same beneficial core functionality (allowing the aquarist 52 to apply three-point loading to produce a higher cleaning force “Fc” with faster reciprocation 34, and when blades 42, 64 are used, to more tightly control the straight blade angle 62 and bowed blade angle 66 than would otherwise be possible). For example, and referring now to FIGS. 9 and 12, another effective but perhaps more costly means is for the sleeve 70 to encompass a rolling contact element such as a linear bearing 96, that also allows the shaft 48 to freely reciprocate 34 relative to the sleeve 70.

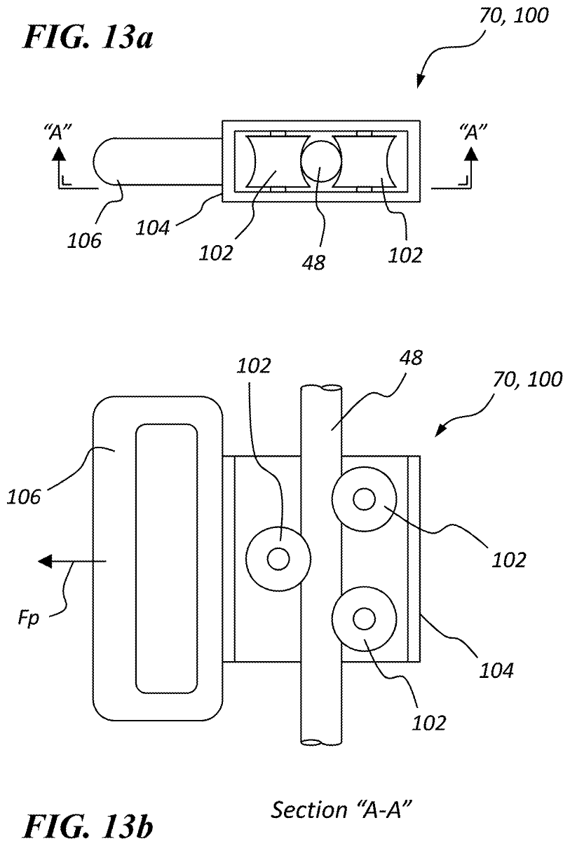

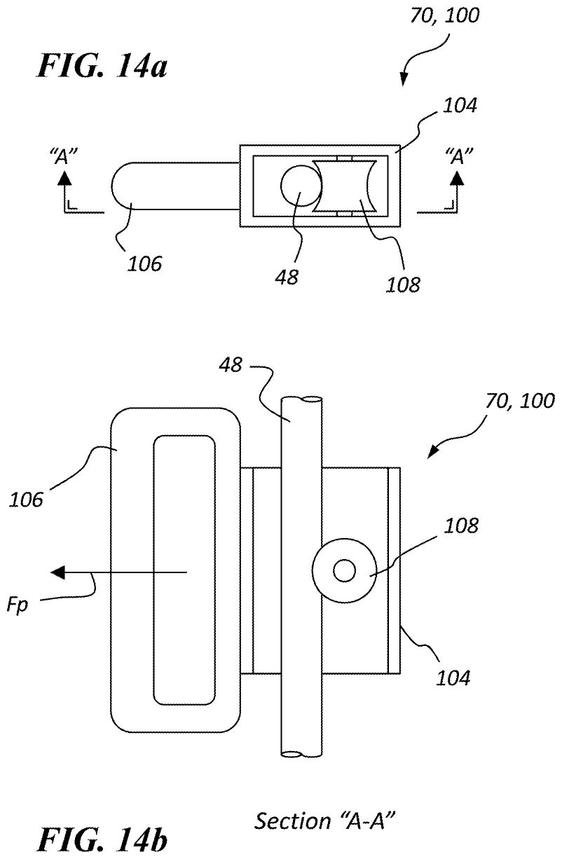

Referring next to FIGS. 7, 8, 11a, 11b, 12, 13a and 13b, the lower sliding grip-sleeve 70 also does not have to be tubular 98 in shape, or even to fully surround the shaft 48. For example, another type of rolling contact element 100 can be used, consisting of opposed rollers 102 mounted within a frame 104 that can be gripped by the aquarist 52 with or without the aid of an attached handle 106. Furthermore, and as shown next in FIGS. 14a and 14b, even a single roller 108 can be sufficient, provided a continuous pulling force “Fp” is applied to the frame 104 to keep the single roller 108 in continuous contact with the shaft 48.

Referring now to FIGS. 7, 8 and 10, while much of the previously described beneficial functionality applies regardless of the type of cleaning element 14, whether a brush or pad 40, or a rigid metal or plastic blade 42, use of a flexible, typically plastic blade 64 is uniquely enabled by the present invention 68 and advantageous for reasons that will now be explained.

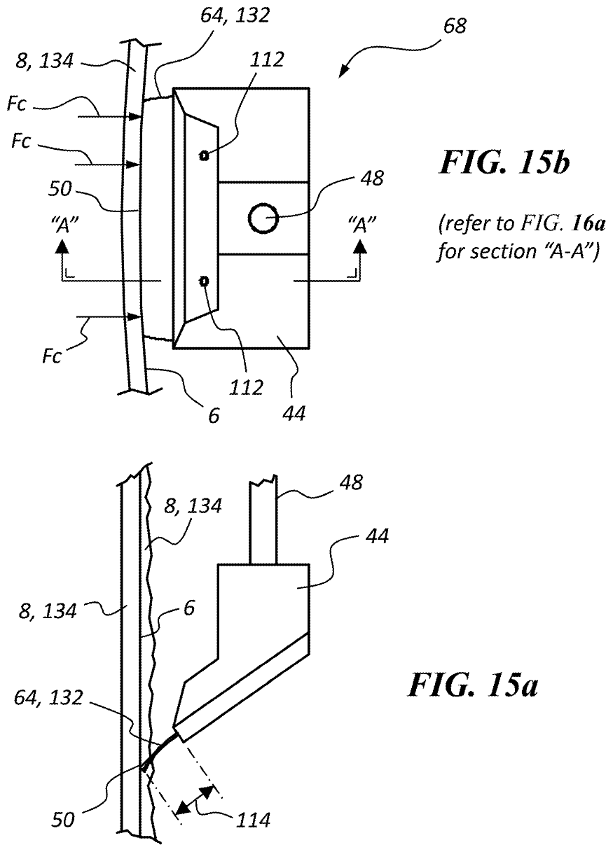

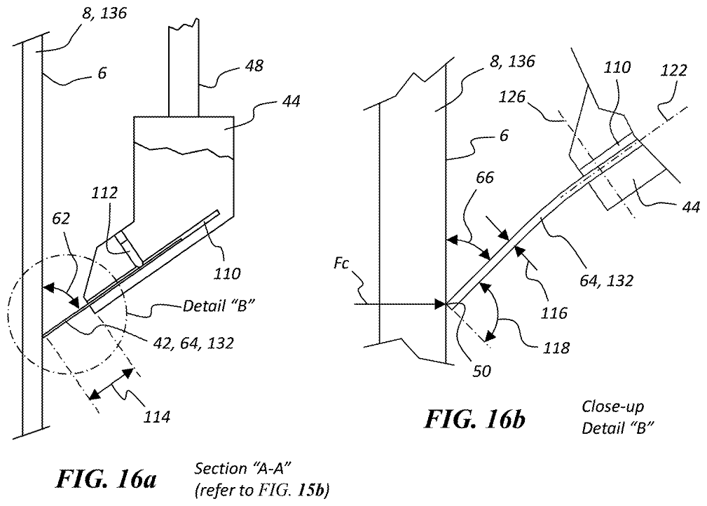

Referring now to the embodiment illustrated in FIGS. 15a, 15b, 16a and 16b, to accommodate use of a rigid blade 42 or flexible blade 64 the cleaning head 44 may include suitable means such as a slot 110 and fastening set-screw(s) 112 to hold the blade 42, 64 in place while allowing it to be easily removed and replaced when worn. The cleaning head 44 may also be designed to hold a flexible blade 64 at a larger straight blade angle 62 than would be suitable for a rigid blade 42, and then permit the flexible blade's extension 114 to be easily adjusted so that under load “Fc” a flexible blade 64 will bow sufficiently to produce a smaller, more optimal bowed blade angle 66.

To be inexpensive while providing suitable flexibility, wear-resistance and edge sharpness, a flexible plastic blade 64 may also have physical properties (elastic modulus, hardness, wear resistance, etc.) similar but not limited to those of a polyvinyl chloride acetate (PVCA) sheet with a thickness 116 between 20 and 40 thousands of an inch thick (approximately 0.5 to 1 mm) and an approximately 90-degree edge angle 118.

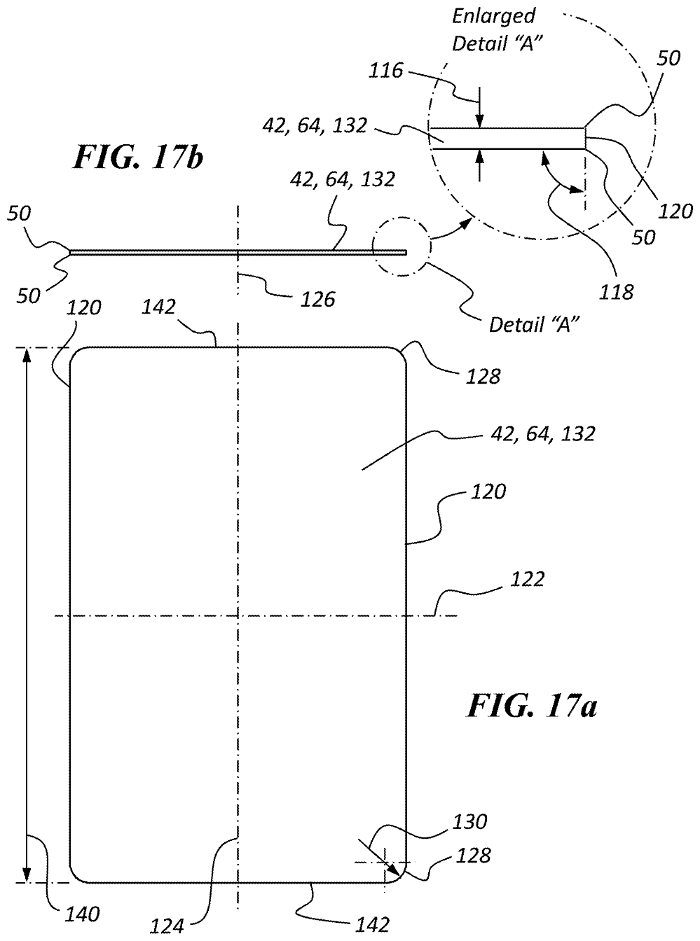

Referring next to FIGS. 7, 10, 15a, 15b, 16a, 16b, 17a and 17b, the rigid blade 42 or flexible blade 64 may also have approximately 90-degree edge angles 118 on at least the two sides 120 that in use are parallel to the aquarium wall 8, so it can be removed when its contacting upper edge 50 wears and then rotated about one or more of its three axes 122, 124, 126 and reinserted into the cleaning head 44, thus allowing up to four 90-degree blade edges 50 to be sequentially used to quadruple the useful life of the blade 42, 64. The corners 128 of the blade 42, 64 are also preferably rounded, with a radius 130 such as 0.125 inches, to eliminate sharp corners that could harm aquarium inhabitants (not shown) or aquarists 52, and that could scratch the inner surfaces 6 of aquarium walls 8, or catch in the soft silicone sealant (not shown) that is typically used to bond aquarium walls 8 together. Additionally, the dimensions of the slot 110 can be designed to allow a standard credit card 132 to be used in lieu of a purpose-specific rigid blade 42 or flexible blade 64.

Referring now to only FIGS. 16a and 16b, and by way of example, the cleaning head 44 can then hold a flexible blade 64, 132 at a straight angle 62 such as 50-60 degrees to the shaft 48 while permitting an adjustable blade extension 114 having a length between 0.125 to 0.75 inches, so when an effective cleaning force “Fc” is applied to the contacting upper edge 50 of the flexible blade 64 it intentionally flexes to assume a lesser bowed angle 66 such as 40-50 degrees.

By permitting adjustment of the extension 114 and hence the bowing of a flexible blade 64, 132 under load “Fc”, the blade 64, 132 can at one extreme with an extension 114 such as 0.625 inches assume a curved line of contact 50 to conform to curved aquarium walls 134, such as those of cylindrical and bowed-front aquariums, and at the other extreme such as with an extension 114 of only 0.25 inches, be stiffened to provide a firmer straight line of contact 50 if desired for flat aquarium walls 136.

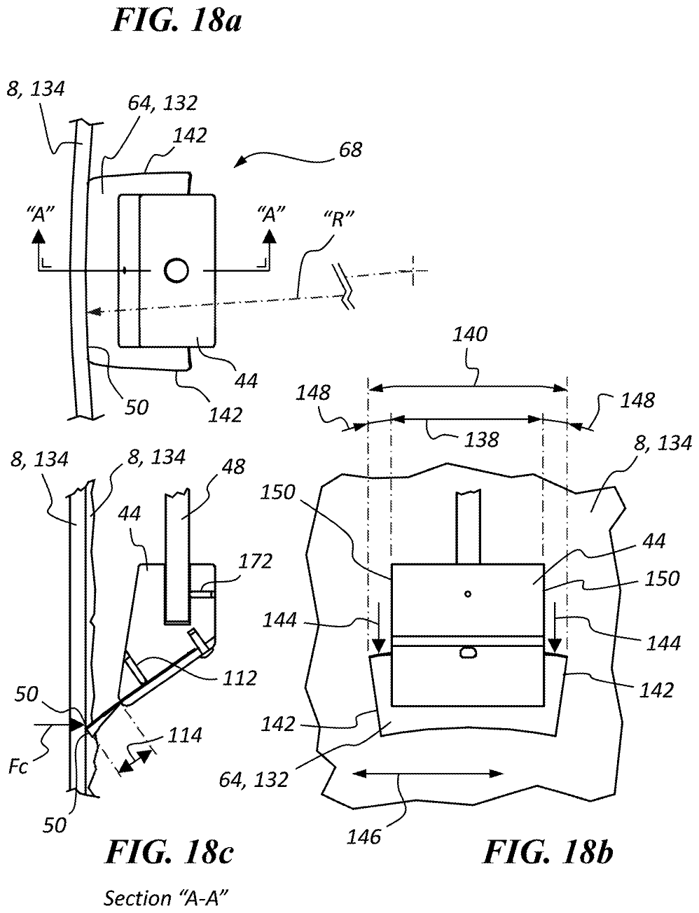

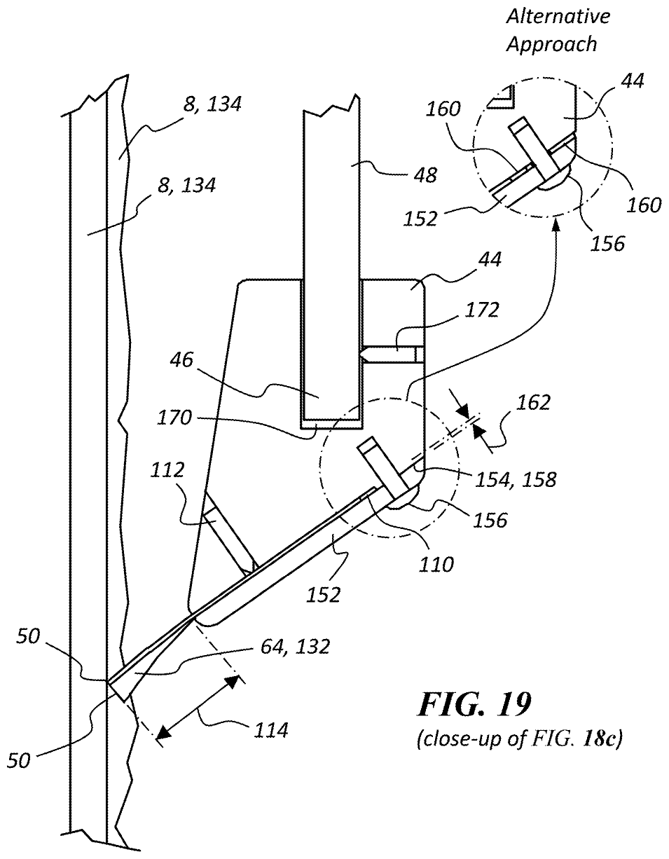

Referring now to FIGS. 16a, 16b, 17a, 17b, 18a, 18b and 18c, to further exploit use of a flexible blade 64, 132 to conform to curved walls 134, the embodiment illustrated in FIGS. 18a, 18b and 18c employs a cleaning head 44 whose width 138 is narrower than the width 140 of the flexible blade 64, 132, thus allowing the blade's overhanging sides 142 to more easily curve downward in the direction of line 144 when the blade 64, 132 is pushed with cleaning force “Fc” into a curved aquarium wall 134. The ability of the overhanging flexible blade 64, 132 to curve not only downward then in the direction of line 144 at its contacting upper edge 50 about the axis 124 parallel to its width 140, but also to curve downward in the direction of line 144 along its sides 142 about the axis 122 perpendicular to its width 140, permits easier formation of an elliptical line of contact 50 that allows the blade 64, 132 to conform to a wider range of aquarium wall 134 curvatures (defined as the reciprocal of the radius “R” of the curved wall 134). This in turn allows the embodiment illustrated in FIGS. 18a, 18b and 18c to be more effectively used to clean both flat walls 136 and curved walls 134 during even the same cleaning session, as is required with bowed-front aquariums, and even to clean curved wall(s) 134 that have varying amounts of curvature across their widths 146 without having to adjust the blade extension 114.

Certain dimensions must of course be maintained within certain ranges for a flexible blade 64 to bend sufficiently about both of its planar axes 122, 124 to conform to typical aquarium wall 134 curvatures while remaining stiff enough to maintain an effective bowed angle 66 to clean both flat walls 136 and curved walls 134. For example, a flexible blade 64 can be manufactured from a PVCA sheet with a thickness 116 between 20 and 40 thousands of an inch and a width 140 of about 3.25 inches, and then can be applied with a blade extension 114 of 0.125 to 0.75 inches and a straight blade angle 62 of 50-60 degrees, using a cleaning head 44 with a width 138 of about 2.75 inches, leaving unsupported lengths 148 of about 0.25 inches. This combination of blade properties and dimensions, and cleaning head dimensions, works well to allow effective cleaning of a wide range of curved walls 134, with a typical such wall 134 having a curvature (defined as the reciprocal of the radius “R”) of about 0.036 in⁻¹ (1.42 m⁻¹).

Referring now to FIGS. 18a, 18b, 18c and 19, the slot 110 of the illustrated embodiment is open-sided to allow the flexible blade's sides 142 to overhang the sides 150 of the cleaning head 44, and the slot 110 can be formed by means such as tightening of a rigid bottom plate 152 against the underside 154 of the cleaning head 44, with the plate 152 being tightened in place by means such as one or more screws 156 that are inserted through the plate 152 into the cleaning head 44.

The top of the bottom plate 152 or the underside 154 of the cleaning head 44 may also include a ledge 158 (or gasket 160 in lieu of) that is slightly thicker 162 than the flexible blade 64, 132, so that when the screw(s) 156 are tightened, the slot 110 is formed into which the blade 64, 132 can be inserted before being locked in place by other means such as set-screws 112. Alternatively, the ledge 158 or gasket 160 may be slightly thinner 162 than the blade 64, 132, thus allowing the bottom plate 152 to clamp the blade 64, 132 to eliminate the need for other fastening means such as set screw(s) 112.

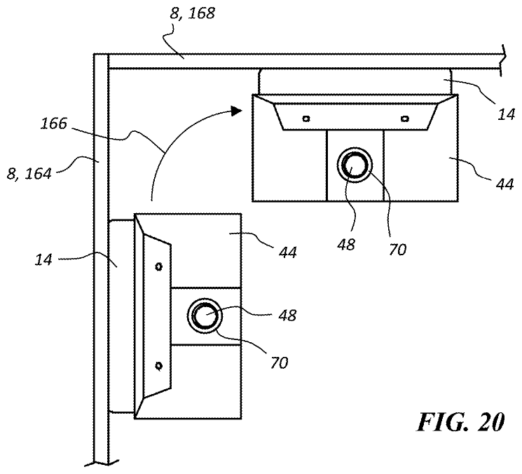

Referring now to FIGS. 7, 8, 11a, 11b, 12, 13a, 13b, 14a, 14b and 20, while many embodiments of the lower sliding grip-sleeve 70 can allow the aquarist 52 to grip the sleeve 70 while allowing the shaft 48 to freely reciprocate 34, the sleeve 70 may also allow the shaft 48 to freely rotate relative to it, thereby allowing the aquarist 52 to clean a first aquarium wall 164 and then to rotate in direction 166 the shaft 48 relative to the gripped sleeve 70 in order to rotate the cleaning head 44 and cleaning element 14 (whether a brush or pad 40, or a blade 42, 64, 132) so as to clean a subsequent wall 168.

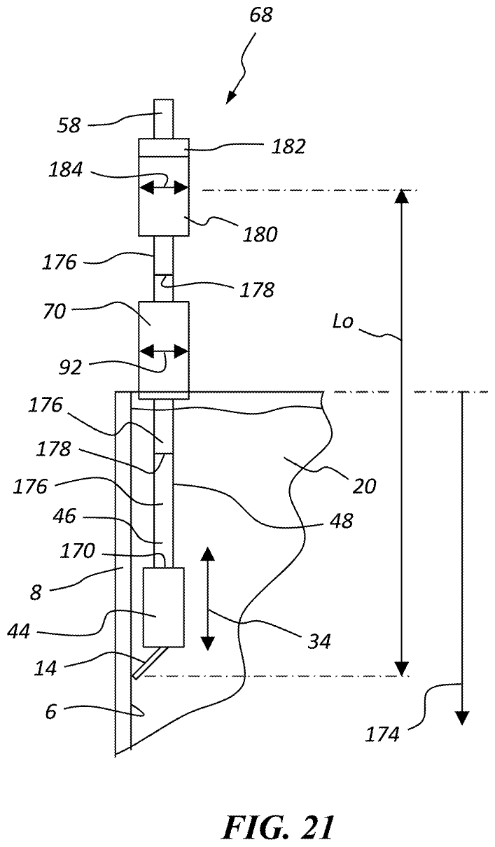

Referring now to FIGS. 7, 8, 9, 18a, 18b, 18c, 19 and 21, the cleaning head 44 may also be attached to the shaft 48 by multiple means, including by inserting the lower end 46 of the shaft 48 into a hole 170 in the cleaning head 44, and then by locking the shaft 48 in place by means such as a threaded connection (not shown) or set-screw(s) 172. The overall shaft length “Lo” can then be lengthened or shortened, allowing the embodiment illustrated in FIG. 21 to be used to clean aquariums 20 of different depths 174 by employing means such as interchangeable shafts 48 of different lengths, telescoping shafts, or multiple shaft segments 176 that attach together by suitable means such as threaded connections 178.

Referring now to FIGS. 7, 8, 9, 11a, 11b and 21, improvements to how the present invention 68 is gripped by aquarists 52 can, by way of example, include a fixed hand-grip 180 that fits over the upper end 58 of the shaft 48, that by suitable means such as a collet 182 may be tightened around the shaft 48 or loosened to allow the passage of interchangeable shafts 48 of different overall lengths “Lo”, or of attachable multiple shaft segments 176. The diameter 184 and contour of any such fixed hand-grip 180 and the outer diameter 92 and contour of the lower sliding grip-sleeve 70 may also be designed to maximize the comfort and firmness of the aquarist's upper 56 and lower 72 grips.

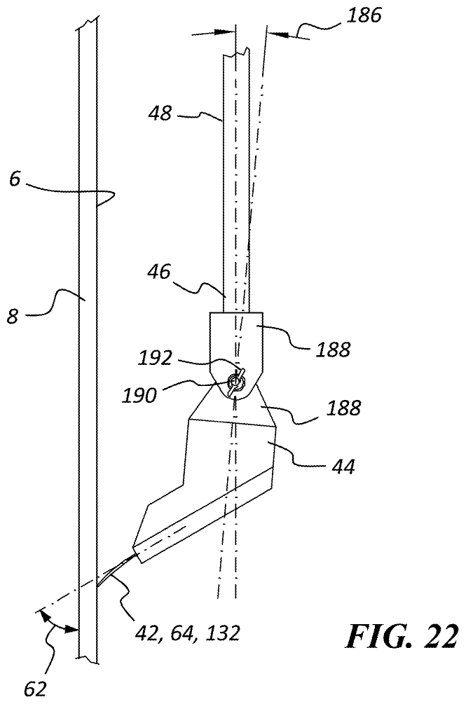

Referring finally to FIGS. 7, 9 and 22, in another embodiment the straight blade angle 62 can be indirectly adjusted by adjusting the angle 186 between the shaft 48 and the cleaning head 44, by incorporating between the lower end 46 of the shaft 48 and the cleaning head 44, a suitable pivoting means, such as a two-part clevis joint 188 along with locking means such as a through-bolt 190 and wing-nut 192.

The foregoing invention has been described with reference to its preferred embodiments. Various alterations and modifications may occur to those skilled in the art. All such alterations and modifications are intended to fall within the scope of the appended claims.

What is claimed is:

1. An aquarium wall cleaner comprising:
a shaft having an upper end and a lower end, the shaft being capable of being gripped toward its upper end by a first hand of an aquarist;
a cleaning head attached to the lower end of the shaft;
a cleaning element attached to the cleaning head;
an intermediate element positioned between the gripped upper end of the shaft and the cleaning head, the intermediate element being capable of being gripped by the second hand of the aquarist and being able to apply a side-load to the shaft while the shaft is still able to freely reciprocate with respect to the intermediate element.

2. The aquarium wall cleaner of claim 1 wherein the intermediate element is a tube positioned around the shaft between the first end and the second end.

3. The aquarium wall cleaner of claim 1 wherein the intermediate element incorporates a rolling contact element positioned within the intermediate element to contact the shaft when the intermediate element is positioned over the shaft.

4. The aquarium wall cleaner of claim 2 wherein the intermediate element is made of a low-friction material that is softer than the material out of which the shaft is made.

5. The aquarium wall cleaner of claim 1 wherein the cleaning element is a flexible blade.

6. The aquarium wall cleaner of claim 5 wherein the extension of the flexible blade may be adjusted.

7. The aquarium wall cleaner of claim 5 wherein the cleaning head is narrower than a width of the flexible blade, allowing the flexible blade to bow about both planar axes when the blade is loaded against a curved aquarium wall.

8. The aquarium wall cleaner in claim 5 wherein the flexible blade has one or more approximately 90-degree edges.

9. The aquarium wall cleaner in claim 8 wherein the blade is removable from the cleaning head.

10. The aquarium wall cleaner of claim 1 wherein the shaft is able to freely rotate with respect to the intermediate element.

11. The aquarium wall cleaner of claim 1 wherein the shaft comprises at least two shaft segments that are attachable to each other to produce shafts of different lengths.

12. The aquarium wall cleaner of claim 1 wherein the cleaning head may be pivoted with respect to the shaft.
